(19) United States
(12) Patent Application Publication
(10) Pub. No.: US 2016/0379724 A1
(43) Pub. Date: Dec. 29, 2016

(54) PART INCLUDING VIBRATION MITIGATION DEVICE(S), NUCLEAR REACTOR PRESSURE VESSEL ASSEMBLY INCLUDING THE PART, AND METHODS OF MANUFACTURING THEREOF

(71) Applicants: James P. CARNEAL, Wilmington, NC (US); William P. DAVIS, Wilmington, NC (US); Myles L. CONNOR, Wilmington, NC (US); David W. WEBBER, Wilmington, NC (US)

(72) Inventors: James P. CARNEAL, Wilmington, NC (US); William P. DAVIS, Wilmington, NC (US); Myles L. CONNOR, Wilmington, NC (US); David W. WEBBER, Wilmington, NC (US)

(73) Assignee: GE-HITACHI NUCLEAR ENERGY AMERICAS LLC, Wilmington, NC (US)

(21) Appl. No.: 14/751,690

(22) Filed: Jun. 26, 2015

(51) Int. Cl. G21C 13/02; G21C 21/00

(52) U.S. Cl. CPC G21C 13/02; G21C 21/00

(57) ABSTRACT

A nuclear reactor pressure vessel assembly includes a part in a reactor housing structure. The part includes a body a vibration absorber. The body includes an internal surface. The internal surface of the body defines at least one cavity that is not exposed to an environment external to the body. The vibration absorber includes at least one of a harmonic oscillator connected to the internal surface of the body or an external surface of the body, a shear multiplier in the at least one cavity, a hybrid mass-viscoelastic structure in the at least one cavity and not secured to the internal surface of the body, and a distributed damping structure incorporated into the body.

### BACKGROUND

Field

The present disclosure relates to a part including vibration mitigation method(s), a nuclear reactor pressure vessel assembly including a part with vibration mitigation method(s), and/or methods of manufacturing the same.

Description of Related Art

In nuclear reactors, such as a boiling water reactor (BWR), the internal reactor parts may be exposed to water, steam, and/or radiation fluence. Chemistry and material issues limit the types of materials that may be used to form internal nuclear reactor parts. Reactor parts formed of stainless steel and/or nickel-based alloys are generally used inside nuclear reactors.

### SUMMARY

Some example embodiments relate to a nuclear pressure vessel assembly including at least one part with a vibration mitigation device(s) and/or methods of manufacturing the same.

Some example embodiments relate to a part including a body and a vibration absorber, and/or methods of manufacturing the same.

Other example embodiments relate to a method of manufacturing a modified part based on a reference part, a method of manufacturing a modified nuclear-reactor part based on a reference part, and/or a modified part manufactured by such methods.

According to an example embodiment, a nuclear reactor pressure vessel assembly includes a reactor housing structure and a part in the reactor housing structure. The part includes a body and a vibration mitigation device(s). The vibration mitigation device(s) may be a vibration absorber(s). The body includes an internal surface. The internal surface of the body defines at least one cavity that is not exposed to an environment external to the body. The vibration mitigation device(s) includes at least one of: a harmonic oscillator connected to the internal surface of the body or an external surface of the body, a shear multiplier in the at least one cavity, a hybrid mass-viscoelastic structure in the at least one cavity and not secured to the internal surface of the body, and a distributed damping structure incorporated into the body.

The nuclear reactor pressure vessel assembly may further include at least one of a shroud, a support plate, a chimney assembly, a core plate, a top guide, a nozzle, a sparger, a fluid separator, a stand pipe, and a dryer. The part may be one of the at least one of the shroud, the support plate, the chimney assembly, the core plate, the top guide, the tubular structure, the nozzle, the sparger, the steam separator, the stand pipe, and the dryer.

The part may be embedded in the reactor housing structure.

The vibration absorber may include the harmonic oscillator. The harmonic oscillator may include at least one spring-mass structure.

The vibration absorber may include the shear multiplier structure. The shear multiplier structure may include a viscoelastic damping material between two layers. At least one end of the shear multiplier structure may be connected to the inner surface of the body.

The vibration absorber may include the hybrid mass-viscoelastic structure, and the hybrid mass-viscoelastic structure may include a viscoelastic damping material surrounding a mass.

The vibration absorber may include the distributed damping structure incorporated into the body. A grain microstructure of the distributed damping structure may include a first material dispersed in a second material, and a damping coefficient of the first material may be greater than a damping coefficient of the second material.

An outer portion of the body may include the second material and not the first material. The outer portion of the body may surround the distributed damping structure such that the distributed damping structure is not exposed to the environment external to the body. The first material may include magnesium. The first material may be magnesium.

The body may be a unibody structure.

The nuclear reactor pressure vessel assembly may further include a plurality of parts. The plurality of parts may include the part in the reactor housing structure. The plurality of part may be in the reactor housing structure.

According to an example embodiment, a part may include a body and a vibrator absorber. The body includes an internal surface. The internal surface of the body defines at least one cavity that is not exposed to an environment external to the body. The vibration absorber includes at least one of a harmonic oscillator connected to the internal surface of the body or an external surface of the body, a shear multiplier structure in the at least one cavity, a hybrid mass-viscoelastic structure in the at least one cavity and not secured to the internal surface of the body, and a distributed damping structure incorporated into the body.

The vibration absorber may include the distributed damping structure incorporated into the housing. A grain microstructure of the distributed damping structure may include a first material dispersed in a second material. A damping coefficient of the first material may be greater than a damping coefficient of the second material.

A material of the body may include one of a low alloy steel, a stainless steel, a nickel-based alloy, and a combination thereof.

The part may be configured to have a natural frequency that is different than a natural frequency of a reference part that does not include a vibration absorber.

The vibration absorber may include the harmonic oscillator.

According to an example embodiment, a method of manufacturing a modified nuclear-reactor part based on a reference part is provided. The method includes forming a body of the modified nuclear-reactor part based on a body of the reference part, and forming a vibration absorber in the modified nuclear-reactor part. The body of the modified nuclear-reactor part has a different structure than the body of the reference part at least because an internal surface of the body of the modified nuclear-reactor part defines at least one cavity that is not exposed to an environment external to the body of the modified nuclear-reactor part. The vibration absorber includes at least one of a harmonic oscillator connected to the internal surface of the body or an external surface of the body, a shear multiplier structure in the at least one cavity, a hybrid mass-viscoelastic structure in the at least one cavity and not secured to the internal surface of the body, and a distributed damping structure incorporated into the body.

According to an example embodiment, a method of manufacturing a modified part based on a reference part is provided. The method includes forming a body of the modified part based on a body of the reference part, and forming a vibration absorber in the part. The body of the modified part has a different structure than the body of the reference part at least because an internal surface of the body of the modified part defines at least one cavity that is not exposed to an environment external to the body of the modified part. The vibration absorber includes at least one of a harmonic oscillator connected to the internal surface of the body or an external surface of the body, a shear multiplier structure in the at least one cavity, a hybrid mass-viscoelastic structure in the at least one cavity and not secured to the internal surface of the body, and a distributed damping structure incorporated into the body.

The forming the vibration absorber in the modified part may include at least one of changing a natural frequency of the modified part relative to a natural frequency of the reference part, and changing a damping level of the modified part relative to a damping level of the reference part such that the damping level of the modified part is greater than the damping level of the reference part.

The changing the natural frequency of the modified part relative the natural frequency of the reference part may include one of adding a mass into the at least one cavity of the modified part, and increasing a stiffness of the modified part such that the stiffness of the modified part is greater than a stiffness of the reference part.

The forming the body of the modified part and the forming the vibration absorber in the modified part may be performed using an additive manufacturing apparatus. The forming the body of the modified part and the forming the vibration absorber in the modified part may be performed using an additive manufacturing method.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 illustrates an example of a nuclear reactor pressure vessel assembly;

FIG. 2A illustrates a sectional view of a rectangular part without an internal damping material according to an example;

FIG. 2B illustrates a perspective view of a cylindrical part without an internal damping material according to an example;

FIGS. 3A to 3F illustrate sectional views of parts according to some example embodiments;

FIG. 4 illustrates a perspective view of a part according to an example embodiment;

FIG. 5 illustrates a sectional view taken along line V-V′ of the part in FIG. 4;

FIG. 6 is a flow chart illustrating a method of making a modified part that is based on a reference part according to an example embodiment; and

FIG. 7 illustrates an example of a nuclear reactor pressure vessel assembly including a part according to an example embodiment.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. In the drawings, like reference numerals in the drawings denote like elements, and thus their description may be omitted.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As used herein, the term natural frequency and resonant frequency are synonymous and may be used interchangeably.

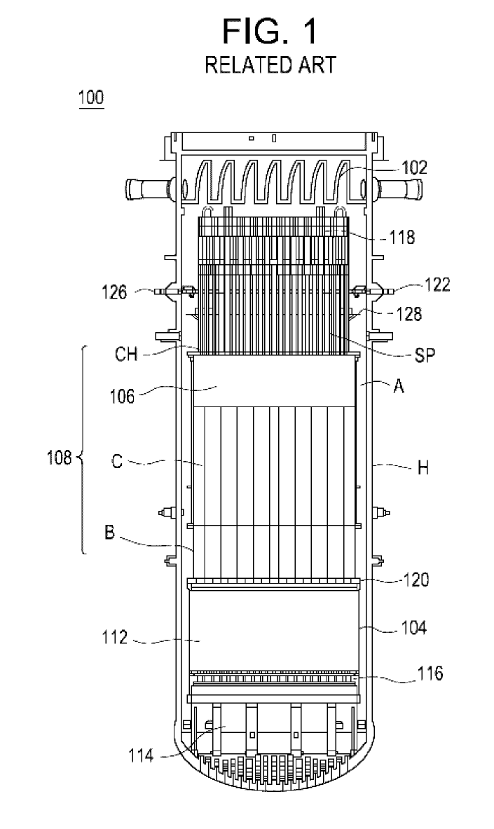

FIG. 1 illustrates an example of a nuclear reactor pressure vessel assembly.

A nuclear reactor pressure vessel assembly is described in U.S. patent application Ser. No. 14/577,364 (filed on Dec. 19, 2014), the entire contents of which is incorporated herein in by reference.

Although the nuclear reactor pressure vessel assembly in FIG. 1 is illustrated without top head (e.g., reactor vessel head), one of ordinary skill in the art would appreciate that a top head may be connected to a top of housing H shown in FIG. 1 in order to enclose the contents within the housing H.

Referring to FIG. 1, the nuclear reactor pressure vessel assembly 100 may include a housing H that surrounds a core inlet region 114, a shroud 104, a reactor core 112, a chimney assembly 108, and steam separators 118. The housing H may be the vertical wall of the reactor pressure vessel assembly 100. The reactor core 112 is over the core inlet region 114. The chimney assembly 108 is between the steam separators 118 and the reactor core 112. The steam separators 118 are over the chimney assembly 108. The reactor core 112 may be defined by an inner surface of the shroud 104, a core plate 116 secured to a bottom of the shroud 104, and a top guide 120 secured to a top of the shroud 104. The shroud 104 may be a hollow cylindrical structure that separates the reactor core 112 from the downcomer annulus flow in the annulus A. The core plate 116 may support control rods and fuel assemblies that include a plurality of fuel rods in the reactor core 112. The top guide 120 may provide lateral support to the top of the fuel assemblies. The core plate 116 may support the control rods laterally. The control rods may be vertically supported by control rod guide housings that are welded to a bottom head in the reactor pressure vessel assembly.

The chimney assembly 108 includes a chimney barrel B, chimney partitions C, a chimney head CH, and a plenum 106. An inner surface of the chimney barrel B defines a space between the reactor core 112 and the steam separators 118. The plenum 106 is a portion of the space defined by the inner surface of the chimney barrel B between a lower surface of the chimney head CH and an upper surface of the chimney partitions C. A height of the plenum 106 may be about 2 meters, but is not limited thereto. The chimney partitions C are located inside the chimney barrel B. The chimney partitions C divide the space defined by the inner surface of the chimney barrel B into smaller sections.

The annulus A is defined by a space between an inner surface of the housing H and outer surfaces of the chimney assembly 108 (e.g., outer surfaces of the chimney barrel B) and reactor core 112 (e.g., outer surface of the shroud 104). Together, an inner surface of the chimney assembly 108 (e.g., inner surface of the chimney barrel B) and an inner surface of the reactor core 112 (e.g., an inner surface of the shroud 104) define a conduit for transporting a gas-liquid two phase flow stream from the reactor core 112 through the chimney assembly 108 to the steam separators 118.

A steam dryer 102 may be connected on top of the steam separators 118. Steam separation occurs as the gas-liquid two phase flow stream enters the steam separators 118. A portion of the gas-liquid two phase flow stream may pass through the steam separators 118 to the steam dryer 102. Additional steam separation occurs as the portion of the gas-liquid two phase flow stream passes through the steam dryer. Steam exiting the reactor pressure vessel assembly through the nozzle adjacent to the steam dryers 102 may be used to power a turbine and produce electricity. A liquid portion of the gas-liquid two phase flow stream that is removed from the steam separators 118 and steam dryer 102 may form a downcomer flow stream in the reactor pressure vessel assembly 100.

The reactor pressure vessel assembly 100 includes at least one feedwater sparger 126 in the housing H that is configured to deliver a subcooled feedwater into the annulus A. A feedwater nozzle 122 may be connected to each feedwater sparger 126 through the feedwater opening defined in the housing H.

Each feedwater sparger 126 is connected to a corresponding feedwater opening defined by the housing H. The reactor pressure vessel assembly 100 may include a plurality of feedwater spargers 126 arranged in a circular pattern over the chimney assembly 108 and connected to a plurality of feedwater openings defined by the housing H. The housing defines a feedwater opening for each feedwater sparger 126. The annulus A is in fluid communication with the feedwater opening connected to the feedwater sparger 126 and the conduit for transporting of a gas-liquid two phase flow stream from the reactor core 112 through the chimney assembly 108 to the steam separators 118.

A support plate 128 may be arranged a distance above the chimney head CH, but below a height of the feedwater spargers 126. The support plate 128 may be secured to the chimney head CH. For example, the support plate 128 may be welded to the steam separator stand pipes SP. Chimney head bolds (not shown) may fit inside the support plate 128 through slip fit holes. The support plate 128 may support the outer stand pipes, and may support the chimney head bolts, laterally.

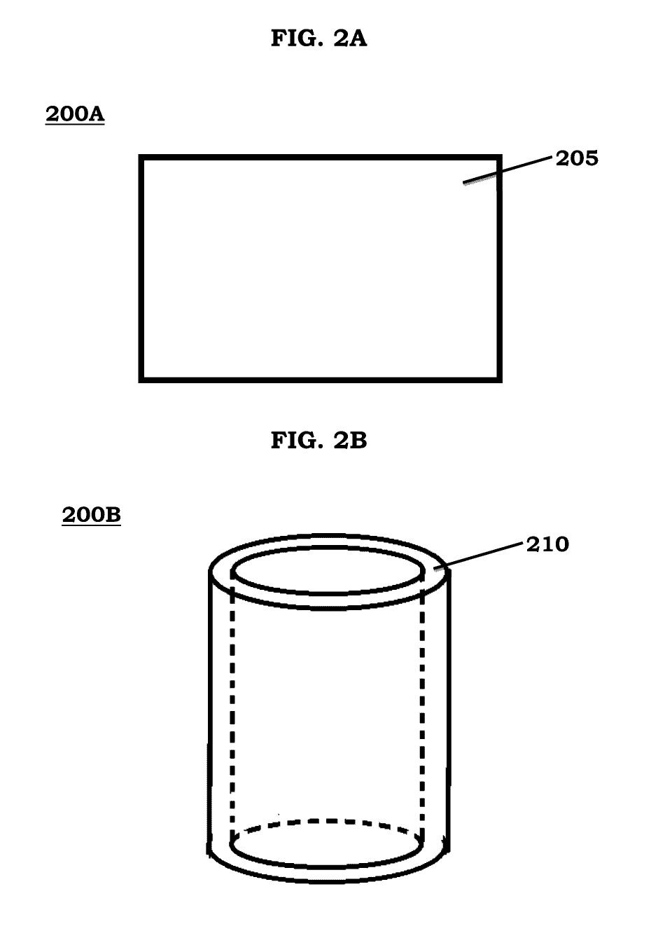

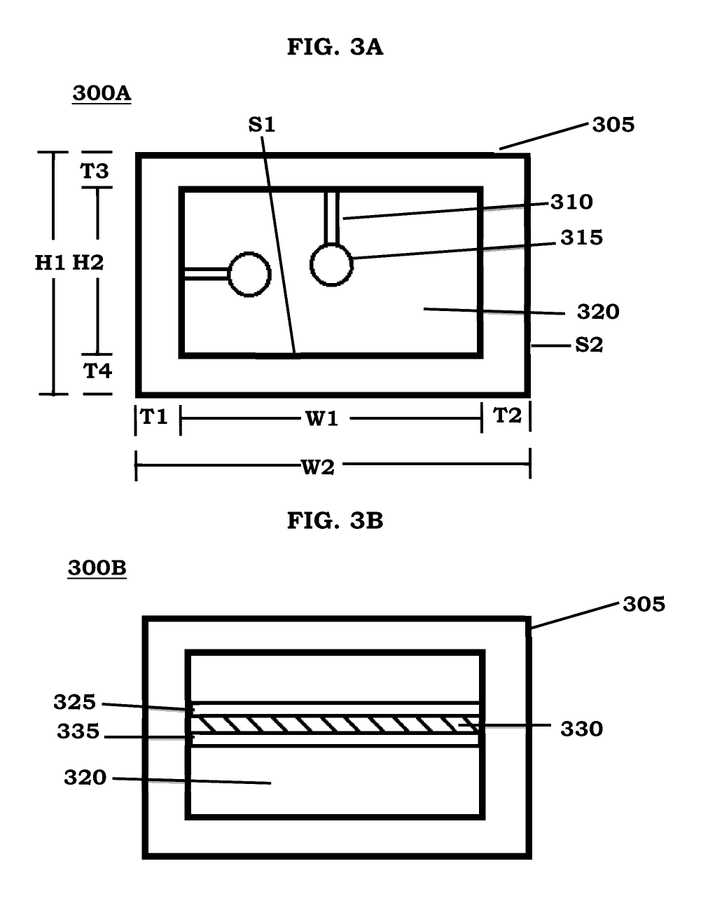

FIG. 2A illustrates a sectional view of a rectangular part without an internal damping material according to an example.

Referring to FIG. 2A, the rectangular part 200A may have a rectangular perimeter. The rectangular part 200A may have a solid structure with no internal cavity. The rectangular part 200A may be made of the same material throughout a thickness of the rectangular part 200A, but is not limited thereto. The rectangular part 200A may be formed of a material that is suitable for the environment related to the intended application of the rectangular part. In this regard, one of ordinary skill in the art could select a material for the rectangular part based on desired material mechanical, chemical, and/or electrical characteristics.

For example, if the rectangular part 200A is used inside a nuclear reactor (e.g., boiling water reactor), the rectangular part 200A may be formed of a material that is resilient to the pressures, temperature, and chemistry environment inside the nuclear reactor. For example, if the rectangular part 200A is used inside a nuclear reactor, the rectangular part 200A may be formed of a low alloy steel, stainless steel (e.g., type 304, 316), a nickel-based alloy, and/or combinations thereof. In particular, if the rectangular part 200A is used inside a nuclear reactor, a material of an exterior surface 205 may be formed of a material that is resilient to the operating environment inside the nuclear reactor, such as low alloy steel, stainless steel (e.g., type 304, 316), a nickel-based alloy, and/or combinations thereof.

If the rectangular part 200A is used in an application that is different than being placed inside a nuclear reactor (i.e., a non-nuclear-reactor application), then one of ordinary skill in the art may form the rectangular part 200A using a material that is suitable for the non-nuclear-reactor application. The material for the non-nuclear reactor application may be different than low alloy steel, stainless steel, a nickel-based alloy, and/or combinations thereof; however, in some non-nuclear reactor applications, low alloy steel, stainless steel, a nickel-based alloy, and/or combinations thereof may be suitable materials for the rectangular part 200A.

FIG. 2B illustrates a perspective view of a cylindrical part without an internal damping material according to an example.

Referring to FIG. 2B, the cylindrical part 200B may be the same as the rectangular part 200A described above, except for the difference in shape. The cylindrical part 200B may have a tubular shape, but other shapes are possible (e.g., rod shape, bolt shape, etc.).

Like the rectangular part 200A described above, if the cylindrical part 200B is used inside a nuclear reactor, the cylindrical part 200B may be formed of a low alloy steel, stainless steel (e.g., type 304, 316), a nickel-based alloy, and/or combinations thereof. In particular, if the cylindrical part 200B is used inside a nuclear reactor, a material of an exterior surface 210 may be formed of a material that is resilient to the operating environment inside the nuclear reactor, such as low alloy steel, stainless steel (e.g., type 304, 316), a nickel-based alloy, and/or combinations thereof.

Like the rectangular part 200A described above, if the cylindrical part 200B is used in an application that is different than being placed inside a nuclear reactor (i.e., a non-nuclear-reactor application), then one of ordinary skill in the art may form the rectangular part 200A from a material that is suitable for the non-nuclear-reactor application.

Although FIGS. 2A and 2B illustrate non-limiting examples of a rectangular part 200A and a cylindrical part 200B (e.g., tubular in shape), the parts 200A and 200B in FIGS. 2A and 2B may be modified to form different shapes, depending on the desired structure for a particular part.

For example, referring to FIG. 1, the shape of the rectangular part 200A and/or cylindrical part 200B may be modified to form the housing H of the reactor pressure vessel assembly 100 described in FIG. 1 above and/or any of the parts inside the reactor pressure vessel assembly (e.g., steam dryer 102, shroud 104, chimney assembly 108 and/or components thereof, components of the reactor core 112, components of the core inlet region 114, core plate 116, steam separators 118, stand pipes SP, support plate 128, feedwater nozzle 122, feedwater sparger 126, support plate 128, etc.).

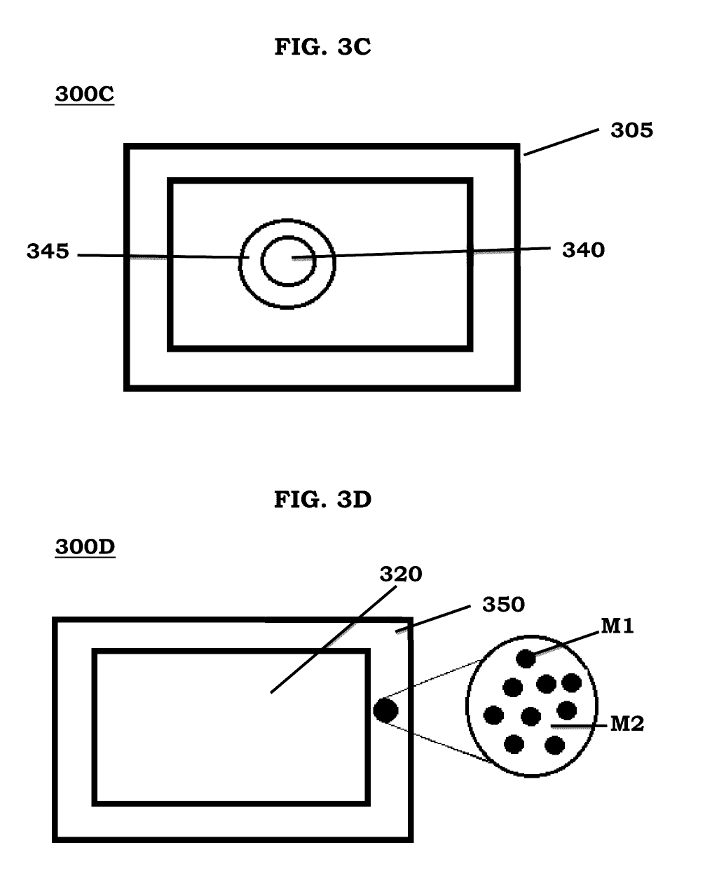

FIGS. 3A to 3F illustrate sectional views of parts according to some example embodiments.

Referring to FIG. 3A, in an example embodiment, a part 300A may include a body 305. The body 305 may include an internal surface 51 and an external surface S2 that are opposite each other. The internal surface 51 of the body may define at least one cavity 320 that is not exposed to an environment that is external to the body 305. The cavity 320 may be empty space or filled with a fluid. The fluid may be a liquid. A material of the fluid may be selected based on a desired viscosity in order to change damping characteristics in the part 300A. The body 305 may have a unibody structure.

The part 300A may include at least one vibration mitigation device connected to the internal surface 51 of the body 305. For example, the part 300A may include at least one vibration absorber connected to the internal surface 51 of the body 305. The vibration absorber may be in the form of a harmonic oscillator. For example, as shown in FIG. 3A, the part 300A may include a harmonic oscillator in the form of a spring-mass structure. The spring-mass structure may include a mass 315 and a spring portion 310. The mass 315 may be connected to the internal surface 51 of the body 305 using a spring portion 310. The cavity 320 in the part 300A shown in FIG. 3A includes a first spring-mass structure and a second spring-mass structure defined by masses 315 respectively connected to the internal surface 51 of the body 305 using spring portions 310 at top and side portions of the cavity 320. However, such a configuration is a non-limiting example. The part 300A could include more or fewer spring-mass structures connected to the internal surface 51 of the body 305 at different locations in the cavity 320. Additionally, the part 300A may include at least one spring-mass structure having a first size (e.g., mass 315 is a first diameter or spring 310 is a first length) and at least one spring-mass structure having a second size (e.g., mass 315 is a second diameter or spring 310 is a second length) that are respectively connected to different locations of the internal surface 51 of the body 305. The first size and the second size may be different than each other. For example, in one spring-mass system, the size of the mass and/or dimensions of the spring portion may be different than the size of the mass and/or dimensions of the spring portion in a different spring-mass system.

The spring portion 310 and mass 315 may be formed of the same materials or different materials than each other. The spring portion 310 may be formed of an elastic material. In some applications, the spring portion 310 may be formed of a metal, a metal alloy, a non-metal, and/or combinations thereof. The mass portion 315 may be formed of a metal, a metal alloy, a non-metal, and/or combinations thereof. In some applications, the spring portion 310 and/or the mass 315 may be formed of the same base material as the body 305. In other applications, the spring portion 310 and/or the mass may be formed of a combination of the base material of the body 305 and a mass-dampening material such as a magnesium alloy. Example embodiments are not limited to the above-reference materials for the spring portion 310 and/or the mass 315. One of ordinary skill in the art would appreciate that the respective materials for the spring portion 310 and/or the mass 315 may be selected depending on the environment where the part 300A is used.

A width of the cavity W1 is less than a width W2 of the part 300A. The width W1 of the cavity 320 may be defined by a portion of the body 305 having a first thickness T1 that is opposite a portion of the body 305 having a second thickness T2. A height H1 of the part 300A is greater than a height H2 of the cavity 320. The height H2 of the cavity 320 may be defined by a portion of the body 305 having a third thickness T3 that is opposite a portion of the body having a fourth thickness T4. The cavity 320 may be surrounded by portions of the body 305 having the first to fourth thicknesses T1 to T4 respectively. The first thickness T1 may the same as the second thickness T2 or different than the second thickness T2 (e.g., T1 may be greater than T2 or less than T2). The third thickness T3 may the same as the fourth thickness T4 or different than the fourth thickness T4 (e.g., T3 may be greater than T4 or less than T4). The thicknesses T1 to T4 may independently be the same as each other or different from each other. The thicknesses T1 to T4 may be sized to limit (and/or prevent) the spring-mass systems inside the cavity 320 from being exposed to an environment outside of the body 305, as well as provide sufficient strength for the part 300A.

Referring to FIG. 3B, in an example embodiment, a part 300B may have the same structure as the part 300A described in FIG. 3A except for the type of vibration mitigation device (e.g., vibration absorber) in the cavity 320.

The part 300B may have a vibration absorber in the form of a shear multiplier structure inside the cavity 320. The shear multiplier structure may include a viscoelastic damping material 330 between a first layer 325 and a second layer 335. The viscoelastic damping material 330 may include a polymer having a viscoelastic property. The first layer 325 and the second layer 335 may be formed of different materials than the viscoelastic damping material 330. The first layer 325 and the second layer 335 may be formed of the same material or different materials from each other. The first layer 325 and the second layer 335 may respectively be formed of one of a metal, a metal alloy (e.g., stainless steel), a ceramic, but are not limited to these materials.

At least one end of the first layer 325 and at least one end of the second layer 335 may be connected to the inner surface 51 of the body 305. In other words, at least one end of the shear multiplier structure may be connected to the inner surface 51 of the body 305.

Although FIG. 3B illustrates an example where only one shear multiplier structure is in the cavity 320, example embodiments are not limited thereto and the part 300B may include a plurality of shear multiplier structures in the cavity. The plurality of shear multiplier structures may be spaced apart from each other.

Also, although FIG. 3B illustrate an example where the first layer 325, viscoelastic damping material 330, and second layer 335 extend parallel to a bottom surface of the cavity 320, example embodiments are not limited thereto. For example, in an example embodiment, the part 300B may be modified so the first layer 325, viscoelastic damping material 330, and second layer 335 extend from a bottom surface of the cavity to a top surface of the cavity 320. Alternatively, the first layer 325, viscoelastic damping material 330, and second layer 335 may extend diagonally to connect to any surfaces of the cavity 320.

Referring to FIG. 3C, in an example embodiment, a part 300C may have the same structure as the part 300A described in FIG. 3A, except for the type of vibration mitigation device (e.g., vibration absorber) in the cavity 320. Instead, the part 300C may include a vibration absorber in the form of a hybrid mass-viscoelastic structure in the cavity 320. The hybrid mass-viscoelastic structure may be in the form of a mass 340 surrounded by a viscoelastic damping material 345. The mass 340 may have a spherical shape, but is not limited thereto. The shape of the viscoelastic damping material 345 may cover all or a portion of the mass 340. The hybrid mass-viscoelastic structure may be arranged so the hybrid mass-viscoelastic structure is not secured to the inner surface of the cavity 320.

Referring to FIG. 3D, in an example embodiment, a part 300D may have the same structure as the part 300A described in FIG. 3A, except for the structure of the body 305 and/or presence of a vibration mitigation device (e.g., vibration absorber)in the cavity 320.

As shown in FIG. 3D, a distributed damping structure may be incorporated into the body 350 of the part 300D. A grain microstructure of the distributed damping structure may include a first material M1 dispersed in a second material M2. A damping coefficient of the first material M1 may be different than a damping coefficient of the second material M2. The damping coefficient of the first material M1 may be greater than the damping coefficient of the second material M2.

An outer portion of the body 350 may include the second material M2 and not the first material M 1. The outer portion of the body 350 may surround the distributed damping structure such that the distributed damping structure is not exposed to the environment external to the body 350.

The first material M1 may be formed of magnesium or include magnesium. The second material M2 may include one of low alloy steel, stainless steel, nickel-based alloy, and a combination thereof. However, example embodiments are not limited thereto and materials for the first material M1 and second material M2 may be different than the aforementioned materials depending on the environment where the part 300D is used. The body 350 may have a unibody structure.

The part 300D may include a cavity 320 that does not include a vibration absorber in the cavity 320. Alternatively, the part may include at least one vibration absorber (e.g., harmonic oscillator, shear multiplier, hybrid mass-viscoelastic structure) connected to the inner surface of the cavity defined by the body 350.

Referring to FIG. 3E, a part 300E according to an example embodiment may include different types of vibration mitigation devices (e.g., vibration absorbers). For example, the cavity 320 may include one or more spring-mass structures, one or more shear multipliers, and/or one or more hybrid mass-viscoelastic structures inside the cavity 320. The body of the part 300E may have the distributed damping structure of the body 350 described in FIG. 3D. Alternatively, the body of the part 300E may be the same as the body 305 of the part 300A in FIG. 3A.

Referring to FIG. 3F, in an example embodiment, a part 300E may be the same as the part 300A described with reference to FIG. 3A, except the spring-mass structures may be attached to an exterior surface of the body 305 instead of the interior surface S1 of the body. Alternatively, although not shown, the part 300E may further include at least one spring-mass structure in the cavity 320 and connected to the inner surface of the body 305. Alternatively, any of the parts 300A to 300D described in FIGS. 3A to 3D may be modified to include spring-mass structures on the exterior surface of the body.

Although FIGS. 3A to 3F illustrate a non-limiting example where the cavity 320 has a rectangular shape and the body 305 has a rectangular shape, one of ordinary skill in the art would appreciate that the cavity 320 may alternatively have a different shape than the shape of the perimeter of body 305. For example, by increasing the thickness of T1 and/or T2 relative to T3 and T4, the shape of the cavity 320 may be changed to a square shape. Also, the internal surface S1 of the parts 300A to 300F described above could be modified to define a cavity 320 having various shapes such as a curved shape (e.g., circular or elliptical), a tapered shape, etc. Additionally, the parts 300A to 300E are illustrated as each having one cavity 320, but example embodiments are not limited thereto and the parts 300A to 300E may be modified to include a plurality of cavities 320 that are not exposed to an environment that is external to the body 305.

The body 305 may be formed of a same material throughout a thickness the body, but is not limited thereto. Similar to the parts 200A and 200B described above with reference to FIGS. 2A and 2B, the body 305 may be formed of material that is suitable for the environment for the intended application of the parts 300A to 300E. A material of the body may be selected based on desired material mechanical, chemical, and/or electrical characteristics.

For example, if one of the parts 300A to 300E is used inside a nuclear reactor (e.g., boiling water reactor), then the body 305 may be formed of (or at least include) one of low alloy steel (e.g., ASME SA-508), stainless steel (e.g., type 304, 316), a nickel-based alloy, and/or combinations thereof. However example embodiments are not limited thereto. For example, if one of the parts 300A to 300E is used in an application that is different than being placed inside a nuclear reactor (i.e., a non-nuclear-reactor application), then the body 305 may be formed of or at least include a material that is suitable for the non-nuclear-reactor application. The material for the non-nuclear reactor application may be different than low alloy steel, stainless steel, a nickel-based alloy, and/or combinations thereof; however, in some non-nuclear reactor applications, low alloy steel, stainless steel, a nickel-based alloy, and/or combinations thereof may be suitable materials for the body 305.

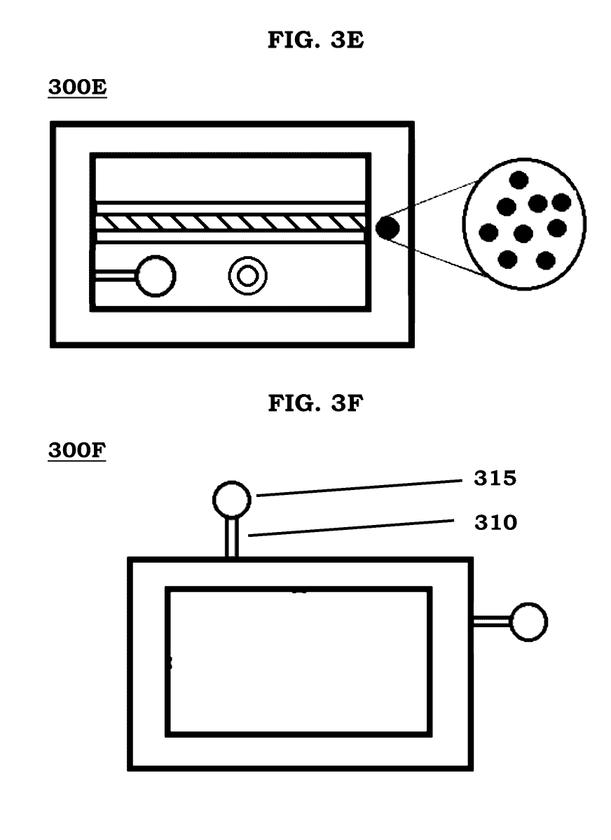

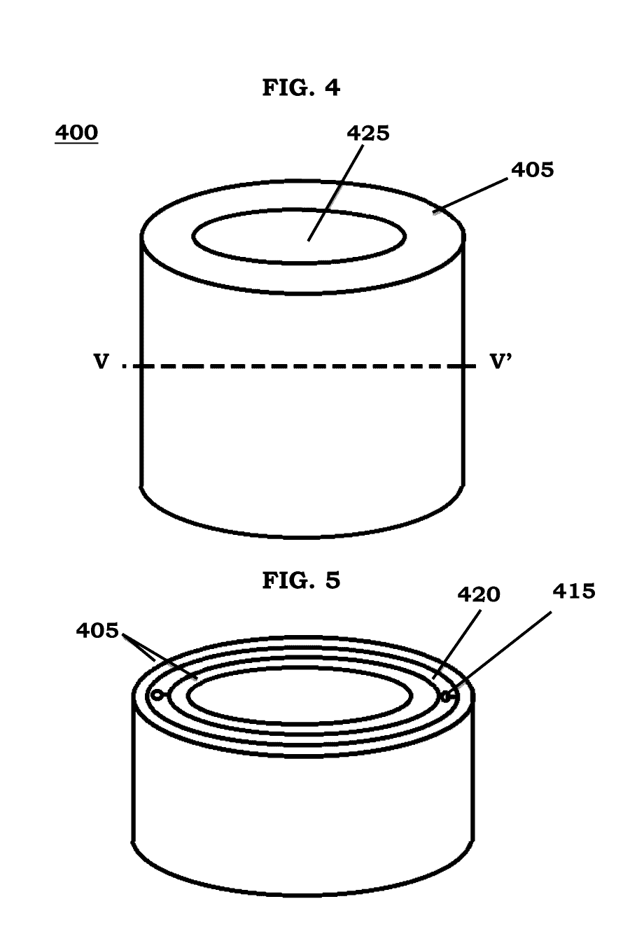

FIG. 4 illustrates a perspective view of a part according to an example embodiment. FIG. 5 illustrates a sectional view taken along line V-V′ of the part in FIG. 4.

Referring to FIGS. 4 and 5, in an example embodiment, a part 400 may have a tubular structure. The body 405 of the part 400 may define an annulus 425 through a length direction of the part 400. Alternatively, the body 405 may have a rod shape without the annulus 425. The body 405 may be formed of the same materials as the body described with reference to FIGS. 3A to 3C and 3E. Alternatively, the body 405 may include a distributed damping structure that is the same material as the body 350 described above with reference to FIGS. 3D and 3E.

As shown in FIG. 5, an inner surface of the body 405 may define a cavity 420 that is not exposed to the environment that is external to the body 405. The cavity 420 may be empty space or filled with a fluid. A material of the fluid may be selected based a desired viscosity in order to change damping characteristics in the part 400. The body 405 may include at least one vibration mitigation device (e.g., vibration absorber) inside the cavity 420. However, FIG. 5 is a non-limiting example . The part 400 alternatively may include a plurality of cavities 420 defined by the inner surface of the body 405 and separated by partitions.

FIG. 5 illustrates a non-limiting example where the body defines one cavity 420 with two harmonic oscillators as the vibration absorbers in the cavity 420. The harmonic oscillators are spring-mass systems 415 attached to the inner surface of the body 405 in the cavity 420. Instead of the spring-mass system 415 or in addition to the spring-mass system 415, the cavity 420 may include any of the types of vibration absorbers discussed above in FIGS. 3A to 3D. For example, the part 400 may include inside the cavity 420 (or cavities 420) at least one spring-mass system 415, at least one shear multiplier structure (see items 325, 330, and 335 in FIG. 3B), at least one hybrid mass-viscoelastic structure based on the mass 340 and viscoelastic damping material 345 described in FIG. 3C, and/or combinations thereof. Also, the part 400 may include at least one spring-mass system 415 attached to the exterior surface of the body 405, similar to the part 300F in FIG. 3F that includes a spring-mass system attached to an exterior surface. If the part 400 includes one or more spring-mass systems 415 attached to an exterior surface of the body 405, then the spring and mass portions of the spring-mass system 415 may be formed of materials that are suitable for the environment where the part 400 is disposed.

Due to mechanical resonance, an object may vibrate with a larger amplitude in response to a force applied at the same (or about the same) frequency as a natural frequency of the object compared to the amount that the object vibrates in response to the same force applied at a frequency that is not close to the natural frequency of the object.

Compared to the part 200A described in FIG. 2A, any one of the parts 300A to 300E in FIGS. 3A to 3F may be configured to have a natural frequency that is different than the natural frequency of the part 200A. In other words, according to some example embodiments, by incorporating at least one vibration absorber in the internal cavity and/or by adding at least one vibration absorber to an external surface, the parts 300A to 300E in FIGS. 3A to 3F may have a different natural frequency than the part 200A in FIG. 2A that does not include a vibration absorber. Accordingly, if a part has a natural frequency that is the same as or about the same as a frequency of the vibration level in the environment where the part is used, a modified part may be formed to have a different natural frequency in order to reduce the vibration of the modified part in the same environment.

Although FIGS. 3A to 3E and FIGS. 4-5 illustrate non-limiting examples of a rectangular parts 300A to 300E and a cylindrical part 400 (e.g., tubular in shape) with at least internal cavity having at least one vibration absorber therein, the parts 300A to 300E and/or 400 may be modified to form different shapes, depending on the desired structure for a particular part.

In an example embodiment, a nuclear reactor pressure vessel assembly may include a housing structure, and a part in the reactor housing structure. The part may include a body and a vibration absorber. An internal surface of the body may define at least one cavity that is not exposed an environment external to the body. The vibration absorber may include at least one of a harmonic oscillator connected to the internal surface of the body or an external surface of the body, a shear multiplier in the at least one cavity, a hybrid mass-viscoelastic structure in the at least one cavity and not secured to the internal surface of the body, and a distributed damping structure incorporated into the body. The nuclear reactor pressure vessel assembly may include a plurality of parts in the reactor housing structure. One of more of the plurality of parts may include a body with an internal cavity and at least one vibration absorber in the internal surface of the body. In some applications, a vibration absorber such as a spring-mass system, such as the spring portion 310 and mass 315 in FIG. 3F, may be connected to external surface of the part, provided the spring portion 310 and mass 315 are formed of materials suitable for the environment in the nuclear reactor pressure vessel assembly.

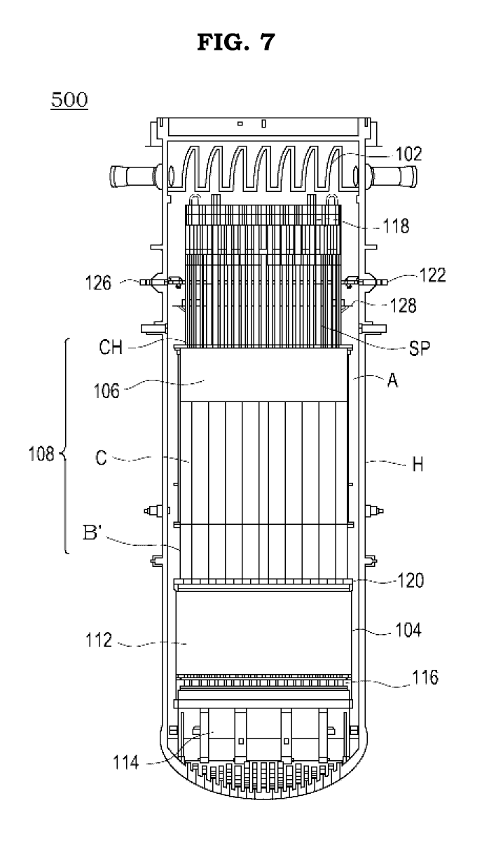

For example, FIG. 7 illustrates an example of a nuclear reactor pressure vessel assembly including a part according to an example embodiment.

Referring to FIG. 7, in an example embodiment, a reactor pressure vessel assembly 500 may be the same as the reactor pressure vessel 100 in FIG. 1, except the chimney barrel B′ has a structure based on the part 400 described in FIG. 4 of the present application.

FIG. 7 is a non-limiting example, where only the chimney barrel B′ has a different structure than a corresponding structure in FIG. 1 of the present application. However, example embodiments are not limited thereto. Referring to FIGS. 1 and 7, the shape of any one of the rectangular parts 300A to 300E and/or the cylindrical part 400 may be modified to form the housing H of the reactor pressure vessel assembly 100 described in FIG. 1 above and/or any of the parts inside the reactor pressure vessel assembly (e.g., steam dryer 102, shroud 104, chimney assembly 108 and/or components thereof, components of the reactor core 112, components of the core inlet region 114, core plate 116, a fluid separator such as one of the steam separators 118, a top guide 120, stand pipes SP, support plate 128, feedwater nozzle 122, feedwater sparger 126, support plate 128, etc.).

If one of the parts 300A to 300E and/or the cylindrical part 400, or a modified shape thereof, is used inside a nuclear reactor pressure vessel assembly, then the material of the body 305, 350, and/or 405 of the parts 300A to 300E and/or 400 may be formed of a material that is suitable for the environment inside the nuclear reactor pressure vessel assembly, such as one of a low alloy steel, a stainless steel, a nickel-based alloy, and a combination thereof. If one of the parts 300A to 300E and/or the cylindrical part 400, or a modified shape thereof, is used inside a nuclear reactor pressure vessel assembly, the resulting part may have a unibody structure.

Also, in an example embodiment, the reactor pressure vessel assembly in FIGS. 1 and/or 7 may include the housing H as the reactor housing structure, but the housing H may be modified in structure to include at least one cavity defined by an inner surface of the housing H and at least one vibration absorber inside the cavity, based on the concepts discussed in the parts 300A to 300E of FIGS. 3A to 3E and/or the part 400 in FIGS. 4-5 of the present application. For example, The housing H may include one or more cavities that each include at least one-spring mass system (see 415 in FIG. 5), at least one shear multiplier structure (see items 325, 330, and 335 in FIG. 3B), at least one hybrid mass-viscoelastic structure based on the mass 340 and viscoelastic damping material 345 described in FIG. 3C, and/or combinations thereof. Also, the housing H may include at least one spring-mass system 415 attached to the exterior surface of the body 405, similar to the part 300F in FIG. 3F that includes a spring-mass system attached to an exterior surface. The housing H may include one of the parts 300A to 300E or the part 400 embedded in the housing H.

Corrosion, fatigue, and wear may degrade parts over time, including parts used inside nuclear reactors. Because of environmental conditions inside nuclear reactors, some vibration damping materials may not be used in parts inside the nuclear reactor if the vibration damping materials are exposed to the water, steam, and/or radiation fluence. According to some example embodiments, at least one vibration absorber may be incorporated into a cavity of the part while the body of the part surrounds the vibration absorber so the vibration absorber is not exposed to an environment that is external to the part. As a result, in a nuclear-parts application, a part according to example embodiment may include at least one vibration absorber that is not exposed to the water, steam, and/or radiation fluence inside the nuclear reactor because the vibration absorber is in a cavity and surrounded by a body of the part.

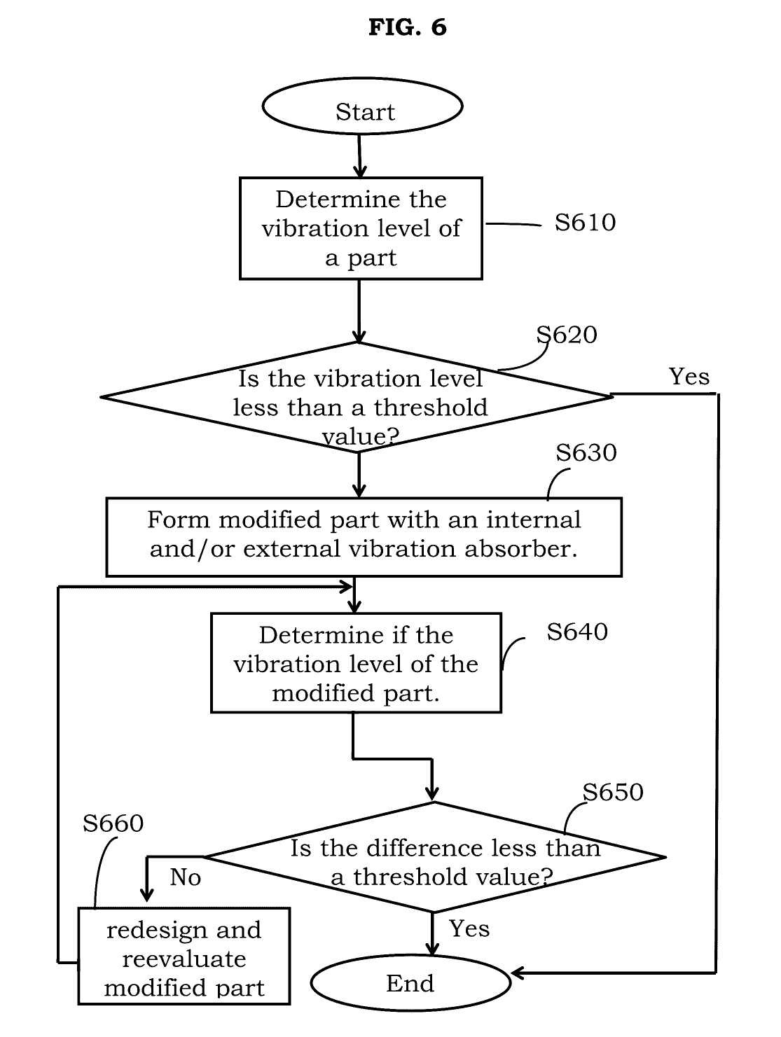

FIG. 6 is a flow chart illustrating a method of making a modified part that is based on a reference part according to an example embodiment.

In operation S610, a vibration level of the reference part may be determined. For example, the reference part may be one of the parts 200A and 200B described in FIGS. 2A and 2B of the present application, but is not limited thereto and could have a different structure. The vibration level of the reference part may be measured. The vibration level of the reference part may be measured while the reference part is used for its intended application or used in an environment that mimics vibration levels that the reference part could be subjected to when used for its intended application.

In operation S620, the vibration level of the reference part may be compared to a threshold value in order to determine if the vibration level of the reference part is less than the threshold value. The threshold value for the vibration level may be a design parameter determined through empirical study. If the vibration level is less than a threshold value (e.g., acceptable vibration level), then it may not be necessary to form a modified part based on the reference part. On the other hand, if the vibration level of the reference part is greater than the threshold value, a modified part with at least one internal and/or external vibration absorber may be formed in operation S630.

The forming the modified part in operation S630 may include at least one of changing a natural frequency of the modified part relative to a natural frequency of the reference part, and changing a damping level of the modified part relative to a damping level of the reference part such that the damping level of the modified part is greater than the damping level of the reference part. Changing the natural frequency of the modified part relative to the natural frequency of the reference part may include adding a mass into the at least one cavity of the modified part.

Alternatively, or in addition, the changing the natural frequency of the modified part relative to the natural frequency of the reference part may include increasing a stiffness of the modified part such that the stiffness of the modified part may be greater than a stiffness of the reference part. However, example embodiments are not limited thereto.

The body of the modified part may be based on the body of the reference part, but the body of the modified part may have a different structure at least because an internal surface of the body of the modified part defines at least one cavity that is not exposed to an environment that is external to the body of the modified part. Additionally, operation S630 may include forming at least one vibration absorber in the cavity of the modified part and/or a vibration absorber attached to an external surface of the modified part.

The natural frequency of the modified part may be changed relative to the reference part in various ways. For example, if the reference part is the part 200A in FIG. 2A of the present application, then the modified part may be based on any one of the parts 300A to 300F of the present application. Similarly, if the reference part is the part 200B in FIG. 2B of the present application, then the modified part may be based on the part 400 in FIGS. 4-5 of the present application. By forming at least one vibration absorber in the cavity of the modified part and/or by forming a vibration absorber attached to an external surface of the modified part, the natural frequency of the modified part may be different than the natural frequency of the reference part.

The method illustrated with reference to FIG. 6 is not limited to the reference parts in FIGS. 2A and 2B of the present application and/or modified part based on FIGS. 3A to 3F and/or FIGS. 4-5 of the present application. One of ordinary skill in the art would appreciate the method in FIG. 6 could be applied to various shapes of parts, not just the reference parts in FIGS. 2A and 2B of the present application and/or modified part based on FIGS. 3A to 3F and/or FIGS. 4-5 of the present application.

Various methods may be used to design the target natural frequency of a modified part based on a reference part. For example, finite element methods, analytical methods, and/or empirical methods such as modal testing may be used. Generally, increasing damping of the reference part by adding a mass-spring system inside the cavity may reduce the natural frequency of the reference part. Generally, adding stiffness to the reference part by adding a shear-multiplier structure may increase the natural frequency of the reference part. However, example embodiments are not limited thereto.

Various techniques may be used to form the modified part. In an example embodiment, the modified part may be formed using an additive manufacturing apparatus or method, also referred to as a three-dimensional printing apparatus or a three-dimensional printing method. In other words, the body of modified part and a vibration absorber in the cavity of the body of the modified part (or attached to an external surface of the body) may be formed using an additive manufacturing apparatus or method. Additive manufacturing provides the ability to mix and match and transition the material from one metal type to another to enhance properties by varying densities and micro-structure. Additive manufacturing allows the formation of hybrid materials and/or parts that include integrated components. Additionally, in some example embodiments, through additive manufacturing, the body of the modified part may be formed as a unibody structure that includes an internal cavity with at least one vibration absorber inside the cavity such that the at least one vibration absorber is not exposed to the environment that is external to the body.

In between operation S620 and S630, if the vibration level of the reference part is greater than the threshold value, analysis may be performed to determine if mechanical resonance accounts for why the vibration level of the reference part is greater than the threshold value in an environment. If mechanical resonance is believed to contribute to the vibration level of the reference part being greater than the threshold value, then forming a modified part that is similar to the reference part but has a different natural frequency may result in the modified part having a lower vibration level than the reference part in the environment where the reference part is used.

In operation S640, the vibration level of the modified part may be determined. For example, the vibration level of the modified part may be measured. Then, in operation S650, the vibration level of the modified part may be compared to the threshold value in order to determine if the vibration level of the modified part is less than the threshold value. The threshold value in operation S650 may be the same as the threshold value used in operation S620. If the vibration level of the modified part is less than the threshold value (e.g., acceptable vibration level), then the modified part may be used without further modification. On the other hand, if the vibration level of the modified part is greater than the threshold value, then the modified part may be redesigned and re-evaluated according to operation S660.

In operation S660, a redesigned modified part may be formed. The re-designed modified part may have the same body shape as the modified part tested in operation S660, except the redesigned modified part may include additional vibration absorbers and/or different vibration absorbers compared to the modified part tested in operation S660. For example, if the modified part is based on the part 300A described in FIG. 3A, the redesigned modified part may be formed to include more than two spring-mass systems inside the cavity, spring-mass systems with a larger mass, or different types vibration absorbers in the cavity. Alternatively, if the body of the modified part in operation S640 does not include a distributed damping structure, then the body of the redesigned modified part may include a distributed damping structure. The above-discussed examples of the redesigned modified part are non-limiting examples and one of ordinary skill in the art would appreciate that numerous variations based on the concepts discussed with reference to FIGS. 3A to 3F and FIGS. 4-5 of the present application are possible.

After the modified part is redesigned to form the redesigned modified part in operation S660, the vibration level of the redesigned modified part may be determined according to operation S640. As shown in FIG. 6, various iterations of operations S640, S650, and S660 may be performed until the vibration level of the redesigned modified part is less than the threshold value.

In an example embodiment, the method in FIG. 6 may be applied to manufacture a modified nuclear-reactor part based on a reference part. The method may include forming a body of the modified nuclear-reactor part based on a body of the reference part. The body may be formed of at least one of a low alloy steel, stainless steel, a nickel-based alloy, and a combination thereof. The body of the modified nuclear-reactor part may have a different structure than the body of the reference part at least because an internal surface of the body of the modified nuclear-reactor part defines at least one cavity that is not exposed to an environment external to the body of the modified nuclear-reactor part. The method may include forming a vibration absorber in the modified nuclear-reactor part. The vibration absorber may include at least one of a harmonic oscillator connected to the internal surface of the body or an external surface of the body, s shear multiplier structure in the at least one cavity, a hybrid mass-viscoelastic structure in the at least one cavity and not secured to the internal surface of the body, and a distributed damping structure incorporated into the body.

When a modified nuclear-reactor part is formed according to the method in FIG. 6, a nuclear-reactor part may include at least one vibration absorber in a cavity such that the at least one vibration absorber is not exposed to steam, water and/or radiation fluence when used in a nuclear reactor. As a result, in an example embodiment, a nuclear-reactor part may incorporate specific vibration damping materials (polymers or high damping materials) in an internal cavity while not allowing the specific vibration damping materials to be exposed to the water, steam, and/or radiation fluence.

For ease of description, a non-limiting example was discussed with reference to FIG. 6 where operation S630 include forming a modified part designed to have a natural frequency that is different than a natural frequency of the reference part. However, each object may have multiple natural frequencies. Accordingly, operation S630 may include designing a modified part that includes multiple vibration absorber systems to change multiple natural frequencies compared to the reference part. For example, each of the parts 300A to 300F discussed in FIGS. 3A to 3F of the present application and/or the part 400 discussed in FIGS. 4-5 of the present application, may be modified to include multiple-vibration absorber systems that are different from each other and designed to change different natural frequencies.

For example, the part 300A in FIG. 3A and/or the part 300F in FIG. 3F may include two or more spring-mass systems that have different properties. The part 300B in FIG. 3B may include two or more shear multiplier structures that have different properties. The part 300C in FIG. 3C could include two or hybrid mass-viscoelastic structures that have different properties. The part 300D in FIG. 3D could include two or more distributed damping structures that have different properties.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

1. A nuclear reactor pressure vessel assembly, comprising:
a reactor housing structure; and
a part in the reactor housing structure,
the part including a body and a vibration absorber,
the body including an internal surface,
the internal surface of the body defining at least one cavity that is not exposed to an environment external to the body, and
the vibration absorber including at least one of,
a harmonic oscillator connected to the internal surface of the body or an external surface of the body,
a shear multiplier in the at least one cavity,
a hybrid mass-viscoelastic structure in the at least one cavity and not secured to the internal surface of the body, and
a distributed damping structure incorporated into the body.

2. The nuclear reactor pressure vessel assembly of claim 1, further comprising:
at least one of a shroud, a support plate, a chimney assembly, a core plate, a top guide, a nozzle, a sparger, a fluid separator, a stand pipe, and a dryer, wherein
the part is one of the at least one of the shroud, the support plate, the chimney assembly, the core plate, the top guide, the tubular structure, the nozzle, the sparger, the steam separator, the stand pipe, and the dryer.

3. The nuclear reactor pressure vessel assembly of claim 1, wherein the part is embedded in the reactor housing structure.

4. The nuclear reactor pressure vessel assembly of claim 1, wherein
the vibration absorber includes the harmonic oscillator, and
the harmonic oscillator includes at least one spring-mass structure.

5. The nuclear reactor pressure vessel assembly of claim 1, wherein
the vibration absorber includes the shear multiplier structure,
the shear multiplier structure includes a viscoelastic damping material between two layers, and
at least one end of the shear multiplier structure is connected to the inner surface of the body.

6. The nuclear reactor pressure vessel assembly of claim 1, wherein
the vibration absorber includes the hybrid mass-viscoelastic structure, and
the hybrid mass-viscoelastic structure includes a viscoelastic damping material surrounding a mass.

7. The nuclear reactor pressure vessel assembly of claim 1, wherein
the vibration absorber includes the distributed damping structure incorporated into the body,
a grain microstructure of the distributed damping structure includes a first material dispersed in a second material, and
a damping coefficient of the first material is greater than a damping coefficient of the second material.

8. The nuclear reactor pressure vessel assembly of claim 7, wherein
an outer portion of the body includes the second material and not the first material,
the outer portion of the body surrounds the distributed damping structure such that the distributed damping structure is not exposed to the environment external to the body, and
the first material includes magnesium.

9. The nuclear reactor pressure vessel assembly of claim 1, wherein a material of the body includes one of a low alloy steel, a stainless steel, a nickel-based alloy, and a combination thereof.

10. The nuclear reactor pressure vessel assembly of claim 1, wherein the body is a unibody structure.

11. The nuclear reactor pressure vessel assembly of claim 1, further comprising:
a plurality of parts, wherein
the plurality of parts include the part in the reactor housing structure, and
the plurality of parts are in the reactor housing structure.

12. A part comprising:
a body including an internal surface,
the internal surface of the body defining at least one cavity that is not exposed to an environment external to the body; and
a vibration absorber including at least one of,
a harmonic oscillator connected to the internal surface of the body or an external surface of the body,
a shear multiplier structure in the at least one cavity,
a hybrid mass-viscoelastic structure in the at least one cavity and not secured to the internal surface of the body, and
a distributed damping structure incorporated into the body.

13. The part of claim 12, wherein
the vibration absorber includes the distributed damping structure incorporated into the housing,
a grain microstructure of the distributed damping structure includes a first material dispersed in a second material, and
a damping coefficient of the first material is greater than a damping coefficient of the second material.

14. The part of claim 12, wherein a material of the body includes one of a low alloy steel, a stainless steel, a nickel-based alloy, and a combination thereof.

15. The part of claim 12, wherein
the part is configured to have a natural frequency that is different than a natural frequency of a reference part, and
the reference part does not include a vibration absorber.

16. The part of claim 12, wherein the vibration absorber includes the harmonic oscillator.

17. A method of manufacturing a modified nuclear-reactor part based on a reference part, comprising:
forming a body of the modified nuclear-reactor part based on a body of the reference part,
the body of the modified nuclear-reactor part having a different structure than the body of the reference part at least because an internal surface of the body of the modified nuclear-reactor part defines at least one cavity that is not exposed to an environment external to the body of the modified nuclear-reactor part; and
forming a vibration absorber in the modified nuclear-reactor part, the vibration absorber including at least one of,
a harmonic oscillator connected to the internal surface of the body or an external surface of the body,
a shear multiplier structure in the at least one cavity,
a hybrid mass-viscoelastic structure in the at least one cavity and not secured to the internal surface of the body, and
a distributed damping structure incorporated into the body.

18. A method of manufacturing a modified part based on a reference part, comprising:
forming a body of the modified part based on a body of the reference part, the body of the modified part having a different structure than the body of the reference part at least because an internal surface of the body of the modified part defines at least one cavity that is not exposed to an environment external to the body of the modified part; and
forming a vibration absorber in the modified part, the vibration absorber including at least one of,
a harmonic oscillator connected to the internal surface of the body,
a shear multiplier structure in the at least one cavity,
a hybrid mass-viscoelastic structure in the at least one cavity and not secured to the internal surface of the body, and
a distributed damping structure incorporated into the body.

19. The method of claim 18, wherein the forming the vibration absorber in the modified part includes at least one of:
changing a natural frequency of the modified part relative to a natural frequency of the reference part, and
changing a damping level of the modified part relative to a damping level of the reference part such that the damping level of the modified part is greater than the damping level of the reference part.

20. The method of claim 18, wherein the changing the natural frequency of the modified part relative the natural frequency of the reference part includes one of:
adding a mass into the at least one cavity of the modified part, and
increasing a stiffness of the modified part such that the stiffness of the modified part is greater than a stiffness of the reference part.

21. The method of claim 18, wherein the forming the body of the modified part and the forming the vibration absorber in the modified part are performed using an additive manufacturing apparatus.
